(19) United States
(12) Patent Application Publication
(10) Pub. No.: US 2005/0172062 A1
(43) Pub. Date: Aug. 4, 2005

(54) Electronic and mechanical system for use with computers

(76) Inventor: Brad Adams, Palos Verdes Estates, CA (US)

Correspondence Address: PEACOCK MYERS AND ADAMS P C, P O BOX 26927, ALBUQUERQUE, NM, 871256927, US

(21) Appl. No.: 11/019,809

(22) Filed: Dec. 20, 2004

Related U.S. Application Data
(60) Provisional application No. 60/531,272, filed on Dec. 18, 2003.

(51) Int. Cl. G06F 13/42

(52) U.S. Cl. 710/305; 361/679

(57) ABSTRACT

An electronic and mechanical system for interconnecting a host computer with peripherals.

### CROSS-REFERENCE TO RELATED APPLICATIONS

This application claims priority to Provisional Patent Application Ser. No. 60/531,272, entitled “Electronic and Mechanical System for Coupling Modular USB Peripherals in a Linear Orientation”, filed on Dec. 18, 2003, and the specification thereof is incorporated herein by reference.

### BACKGROUND OF THE INVENTION

1. Field of the Invention

This invention relates to the field of computers.

2. Background

This invention relates to computers, including personal computers, but not excluding other types of computers and the use of peripherals in cooperation with such computers. The term “peripherals” is a term understood by those having ordinary skill in the art generally referring to devices that are external to a computer and are in data signal communication with a computer. No list of peripherals is included since in the rapidly changing computer industry, any such list would be overly restrictive during the useful life of the present invention. One of the problems in the prior art relates to wire or cable interconnections between peripherals and a computer. More specifically, the peripherals, if not properly physically arranged and interconnected with wires or cables between peripherals and/or a computer can consume a significant portion of the computer user's desktop area. Moreover, the wires between peripherals and between peripherals and the computer can become tangled, mixed, and otherwise create a mass of wires which some of those of ordinary skill in the art refer to as a “rats nest”.

This invention solves prior art problems as described above and other problems in the prior art.

The invention will be described in reference to the most prevalent interconnection system for peripheral and computers used in personal computers today, referred to as to the Universal Serial Bus (USB).

As will be known to those with ordinary skill in the art, there are three physical entities that are referred to in the USB specification: the “host”, the “hub” and the “device.” For the purposes of this document, the terms “physical entities”, “USB entities” and “entities” are used interchangeably. Each of these entities is a standalone electromechanical apparatus that is commercially available from a variety of vendors. Each physical entity has one or more interface connections known as “ports.” The ports are attachment points to which other USB entities can be connected via a USB cable. Ports are referred to as “upstream” ports or “downstream” ports. An upstream port on a device connects to a cable that runs towards the host and a downstream port connects to a cable that runs away from the host.

The physical entity known as the “host” is a USB enabled PC. There can only be one host on a USB. If all the ports on the host are occupied, a user can connect another physical entity known as a “hub” to one of the ports. The upstream port of the hub connects to the host and the hub provides two or more downstream ports that are now available for additional hubs or devices. Multiple tiers of hubs can be connected to allow the connection of up to 127 devices to a single USB host.

The physical entities known as “devices” are the entities that provide utility to the user. The purpose of USB is to allow the user to easily connect and access devices via their host PC. Examples of devices include (but are not at all restricted to) mice, modems, memory card readers and network adapters. Most PC peripherals today employ the USB interface exclusively or are available with a USB interface version.

Manufacturers and developers of USB physical entities employ the use of one or more silicon semiconductors, or “chips” in their designs. These chips determine the functionality and capabilities of the entity. One of these chips, known as the “controller” identifies the entity on the bus as a host, hub, or device and contains the basic instructions that allow it to interact with the other physical entities on the USB. All hosts contain a host controller, all hubs contain a hub controller, and all device physical entities contain a device controller. A device physical entity always has some purpose in addition to merely existing as a USB device. The electronic components, circuitry and other capabilities that enable a device to perform the role of a memory card reader, network adapter or other type of device physical entity are known in USB terminology as a “function.” As reflected in the USB specification, a device physical entity in total can also be known as a function.

### SUMMARY OF THE INVENTION

An electronic and mechanical system for interconnecting a computer with peripherals, also known as “devices”, includes housings for the peripherals and electromechanical interconnection for data communication with the host computer and/or with another peripheral also having a housing including electromechanical interconnection to the first peripheral. Power connections, where required, are also provided. Each of the peripheral devices includes a hub controller, a device controller, and a non-removable function which provides the utility to the computer user.

### BRIEF DESCRIPTION OF THE DRAWINGS

A non-restrictive embodiment of an electronic and mechanical system of the present invention is illustrated in the accompanying drawings as will be understood by those having ordinary skill in the art:

FIG. 1 illustrates a standard USB device;

FIG. 2 illustrates a standard USB hub for interconnecting devices;

FIG. 3 illustrates a USB compound device;

FIG. 4 illustrates an electronic and mechanical device for interconnecting devices in accordance with the present invention;

FIG. 5 illustrates multiple electronic and mechanical devices for connecting multiple devices to a computer;

FIGS. 6A, 6B and 6C illustrate in the first two diagrams prior art methods for interconnecting USB devices to a computer and FIG. 6C is an illustration of one embodiment of one possible electronic and mechanical system in accordance with the present invention for interconnecting devices to a computer;

FIGS. 7A, 7B and 7C illustrate a housing for an electronic and mechanical device in accordance with the present invention;

FIGS. 8A and 8B are perspective views of the housing shown in FIGS. 7A-7C;

FIGS. 9A and 9B illustrate possible implementations of the embodiments shown in FIGS. 7A-7C during assembly;

FIG. 10 is another view of the assembly of housings shown in FIGS. 9A and 9B;

FIG. 11 shows a stack assembled from mechanical and electronic devices shown in the embodiment of FIG. 7; and

FIG. 12 is a perspective view of the stack in FIG. 11.

### DETAILED DESCRIPTION

As known to those of ordinary skill in the art, a typical personal computer at the present time, though practices are always subject to change, has a limited number of USB interface connections sometimes referred to as USB ports. For example, a computer may have between 1 and 10 USB ports though typically only several ports are available on most personal computers and these few ports may be required for connecting basic peripherals such as a computer mouse, keyboard or printer. This list of peripherals is intended solely as exemplary and not meant to exclude other types of peripherals which those skilled in the art may refer to as “basic” peripherals. The particular mechanical and electrical characteristics of the USB port, interface, or interconnection is currently available as specification revision 2.0 and is generally available at, as of this time, www.usb.org. The USB specification is not relied upon for a complete description of the present invention because those of ordinary skill in the art to whom this description is addressed are generally familiar with the current version of the USB specification or have access through readily available public means to the full USB specification for the detailed portions thereof. This description therefore relies upon the ordinary skill in the art relating to USB mechanical-electrical interconnection to provide a complete description of the present invention as well as its context.

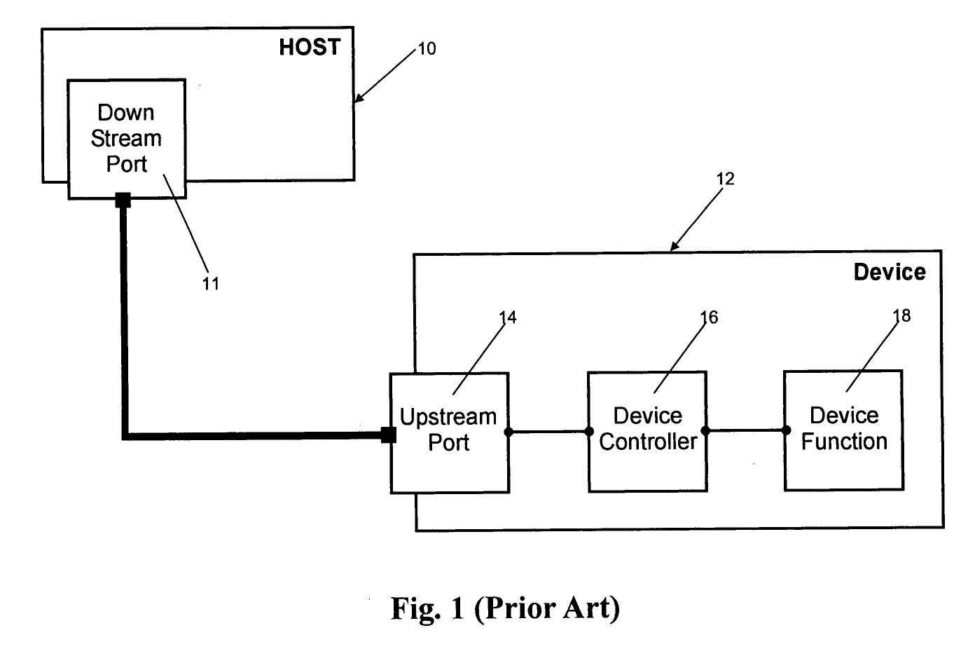

Attention is drawn to FIG. 1 which shows a USB device connected to a computer. This common configuration includes a computer sometimes referred to as a host which to those of ordinary skill in the art would be understood as meaning a standalone computer, indicated at 10 with a USB port 11. The host 10 is connected to a device 12. The device 12 has at least one data interconnection which may, as shown, comprise a single USB data port 14. Port 14 is indicated as an “upstream” port meaning that it is connected to the host. Note that in an alternate scenario upstream port 14 might instead be connected to a hub (not shown). Within device 12 there is provided a device controller 16. The controller, usually implemented on a chip, identifies the device and enables the device to functionally interact with the host. The device function 18 refers to the electronic capabilities that enable the device to perform its intended user tasks. The device controller 16 includes data interconnection between the upstream port 14 and the device function 18 contained within the device housing. The upstream port 14 is connected to the host 10 through a USB cable 20.

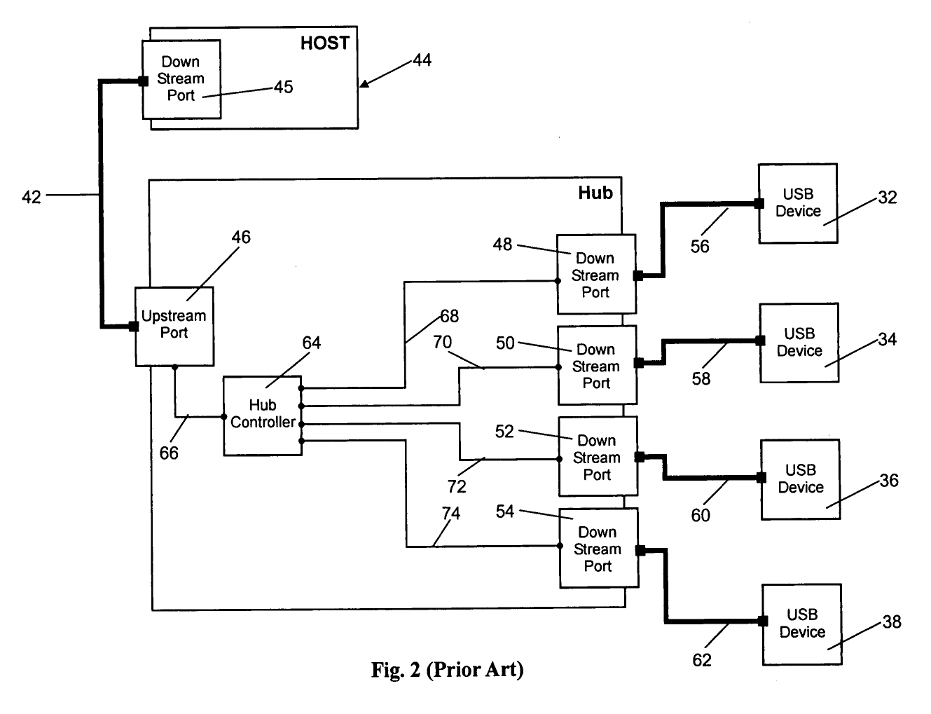

FIG. 2 illustrates another example of implementation of the USB specification as known in the prior art. In this system, multiple devices are indicated at 32, 34, 36, and 38 and are connected through a hub, indicated at 40, which is connected through a cable 42 to a host 44 having a port 45. Hubs are typically used in implementing the USB interconnection scheme when the available ports on the host have been used, for example, by interconnection of basic peripherals. The hub provides data interconnection between multiple devices and a computer. The hub 40 includes upstream port 46, and downstream ports 48, 50, 52 and 54. Device 32 is in data communication with downstream port 48 through USB cable 56. Similarly, device 34 is attached to downstream port 50 through cable 58. Device 36 is attached to downstream port 52 through cable 60 and device 38 is attached to downstream port 54 through cable 62. Thus, as those skilled in the art will appreciate, each of the devices 32-38 are connected through individual cables 56-62 to electromechanical ports 48-54 that comprise one portion of the hub 40. The other portion of the interconnection of hub 40 comprises upstream port 46 which is attached through cable 42 to host, hub, or computer 44. The hub 40 additionally includes hub controller 64 and data connection 66 to upstream port 46 as well as a plurality of data interconnections 68, 70, 72, and 74 which provide data signal communication between hub controller 64 and downstream ports 48, 50, 52 and 54 thus providing data signal interconnection to USB devices 32, 34, 36, and 38.

As those of ordinary skill in the art will appreciate, the hub 40 and devices 32-38 comprise what is commonly referred to as a star topology network. The purpose of the hub 40, as FIG. 2 makes clear, is to attach a plurality of peripheral devices through the hub to a single port in the host computer thus permitting a larger number of peripheral devices to be attached to a host with a limited number of USB interfaces or ports.

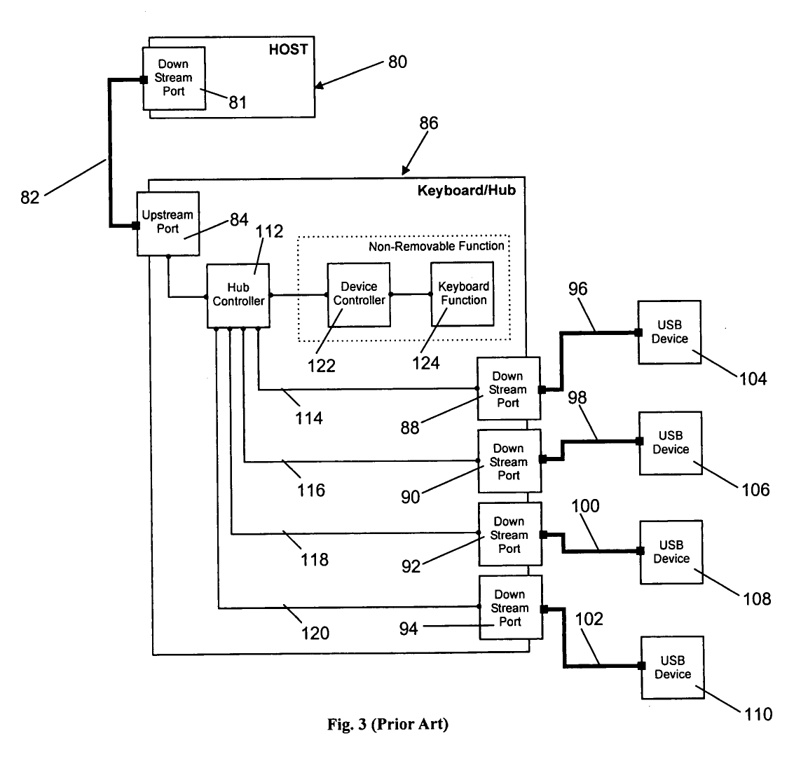

FIG. 3 illustrates still another implementation of the USB specification with a special type of device sometimes referred to as a “Keyboard Hub” and also known as a “Compound Device” in the USB specification existing as of the time of the invention. FIG. 3 shows a host 80 having a port 81 attached through a USB cable 82 to an upstream port 84 of an interconnection device 86 having four downstream ports 88, 90, 92, and 94 each of which is attached through USB cables 96, 98, 100, and 102 to USB devices 104, 106, 108, and 110. Each of the downstream ports are connected to a hub controller 112, through one of four data signal interconnections 114, 116, 118, and 120 for downstream ports 88, 90, 92 and 94, respectively. The compound device 86, although included in the USB specification, is not, as of the time of the invention, highly utilized. A compound device is typically a keyboard, with an embedded USB hub. In other words, compound device 86 includes all of the capability of the hub 40 as shown in FIG. 2, but additionally includes a device controller. The device controller 122 is in data signal communication with hub controller 112, and is connected to, by way of example, a keyboard function 124, through data signal interconnection 126. The device controller 122 is connected to hub controller 112 as a fifth interconnection to hub controller 112 in addition to downstream port interconnections 114-120 so that the total number of interconnections to hub controller 112 is five. The USB specification permits use of a compound device if, and only if, the compound device in addition to including a hub includes a device controller providing a dedicated function for a particular type of peripheral and which function is non-removable from the hub controller. In other words, the device controller 122 and keyboard function 124 are an integral component of a compound device 86 which ordinarily includes multiple downstream ports 88, 90, 92 and 94 for connection to multiple devices 104 through 110 each having a device controller. These devices are selectively connected to the hub controller 112 and may be removed without affecting the functionality of the system; however, device controller 122 and keyboard function 124 cannot be selectively removed.

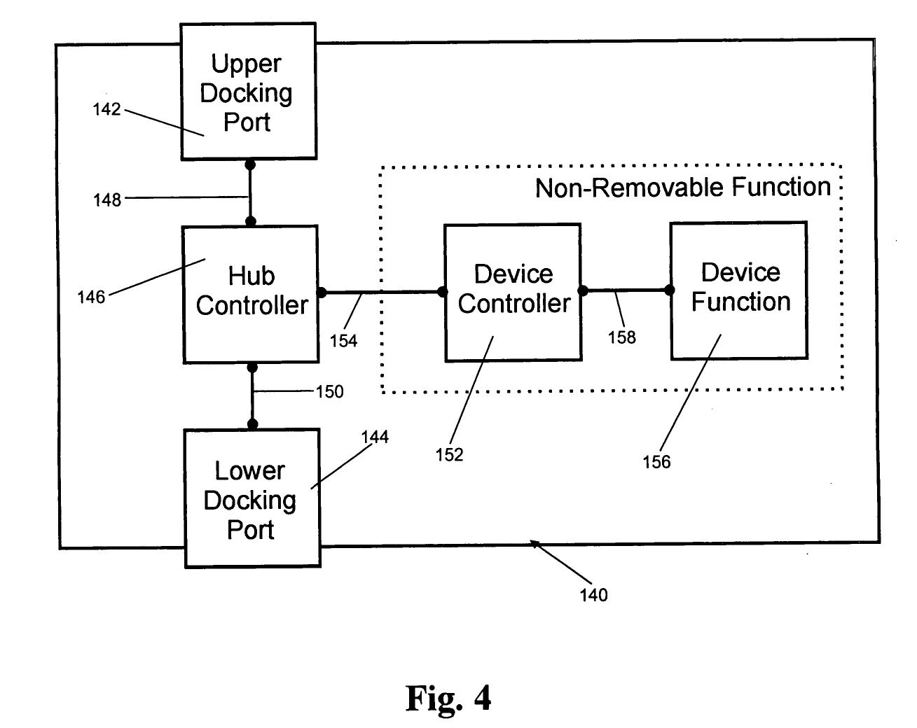

As shown in FIG. 4, one embodiment of the present invention includes a compound device having a particular electrical and mechanical coupling which defines an electronic and mechanical device 140 having an upstream docking port 142, a downstream docking port 144, and a hub controller 146, connected to the upstream docking port 142 through a data signal interconnection 148. The hub controller 146 is connected to the lower docking port 144 through a data interconnection 150. Hub controller 146 is connected to device controller 152, through data signal interconnection 154, which is connected to a device function 156, through data interconnection 158. Unlike the USB specification and prior art configurations, the electronic and mechanical device 140 has an upstream port, a hub controller, and a single downstream port. Thus, device 140 accommodates a single peripheral function but has a downstream port 144 that may be connected to another electronic and mechanical device identical to device 140. The docking port 142, 144 are not like the ports described above (as part of the description of FIGS. 1 through 3) since they connect directly to an adjoining port without use of a cable. Therefore, the docking ports on adjoining devices must be male and female for direct interconnection. The USB specification precludes bus interconnection directly between devices because each such device is subject to failure and such failure will shut down the entire bus topology network. However, a hub controller and a non-removable function as permitted in compound devices which include a device controller and a device function providing the capability within the electronic and mechanical device 140 of a device without violating the principle of one failsafe characteristic of a star topology vis-à-vis a bus topology.

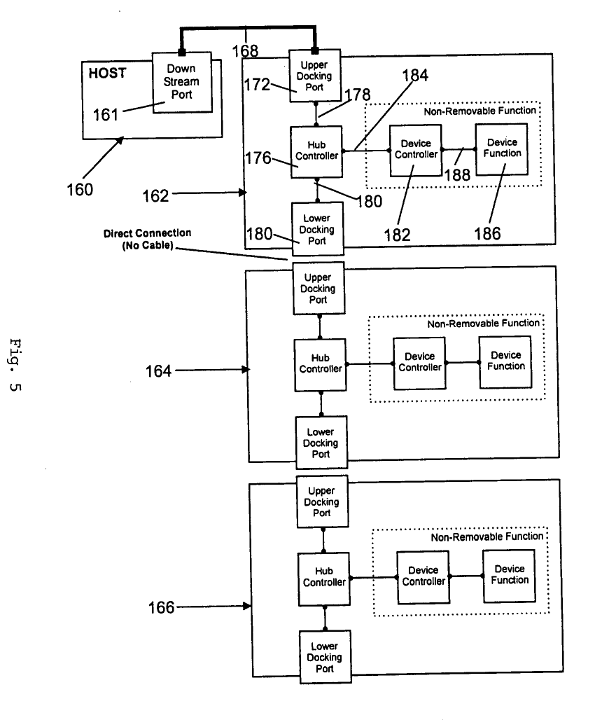

FIG. 5 illustrates a plurality of electronic and mechanical devices 140 in a vertically stacked relationship and in reference to a host 160. Three such devices 162, 164 and 166 are shown. As noted previously, the USB specification does not permit a topology in which one device is physically connected to another device since all devices must be connected to a hub or a host. Also as noted, hubs may be attached to one or more other hubs, and each of the other hubs may be in turn connected to still other hubs to form a daisy chain of hubs up to a total that accommodates 127 USB entities. At least one device may be attached to each hub and, from the point of view of the USB specification; each hub comprises a star topology with a single device. The electronic and mechanical devices 162, 164 and 166 therefore represent, in terms of USB topology, three stars, each serving a single device. The device 162 is connected to host 160 through a USB cable 168. Note that USB cable 168 is the only cable used in connecting devices 162, 164 and 166.

Each of the devices 162, 164 and 166 are identical with respect to their USB interconnectivity, though providing different functions, such as a modem and a memory card reader, and each is identical to peripheral 140 shown in FIG. 4 with respect to USB connectivity. By way of example, peripheral 162 includes an upper docking port 172 (which may have a USB female connector or interface for receiving a male connector on cable 168), and a lower docking port 174 (which may have a USB male connector or interface). Each of the docking ports are connected through data signal connections 178 and 180 to the hub controller 176. The hub controller is also connected to a device controller 182 through a data signal connection 184 and the device controller is connected to a device function 186 through a data connection 188. The device controller 182 and device function 186 are referred to in the USB specification as a “non-removable function” which is also defined as a “compound device”. Although the devices 162, 164 and 166 are shown in a vertically stacked relationship, it will be understood that the devices may reside in a horizontal plane or in any other physical configuration although for the reasons set forth below, the vertical stacking relationship is preferable.

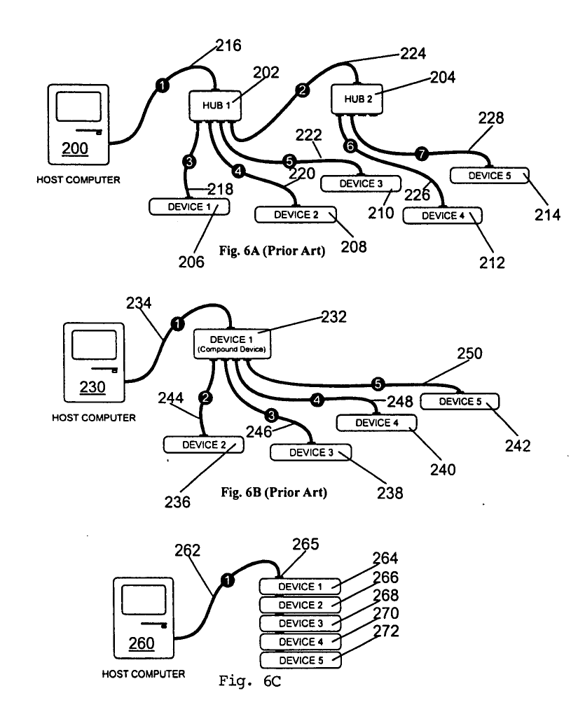

Referring now to FIG. 6, one of the advantageous features of the invention, the elimination of a plurality of USB cables between hubs and between a hub and devices as well as between the hub and the host computer, is illustrated. A typical prior art physical topology using a standard USB configuration is shown in FIG. 6A. The host computer 200, is connected to two hubs 202 and 204. Hubs 202, 204 are connected to five devices 206, 208, 220, 212 and 214. As noted previously, under the USB standard the hub 202 may accommodate up to four devices. Thus, hub 202 is connected upstream through a USB cable 216 and downstream to device 206 through cable 218, device 208 through cable 220, to device 210, through cable 222, and to second hub 204 through cable 224. For purposes of illustration, hub 204 is connected to a two devices 212 and 214 through cable 226 and cable 228. As seen in FIG. 6A, there are seven USB cables used to attach the five devices through two hubs to one computer.

FIG. 6B shows an alternative USB mechanical-electronic interconnection for five devices to a host computer 230 which includes a compound device 232 connected by a single USB cable 234 to a single port in the computer 230. Compound device 232 is not a hub but rather has both a hub controller as well as a dedicated or non-removable function for a peripheral, such as a keyboard. The compound device 232 is connected to four devices 236, 238, 240 and 242. Each of the devices 236-242 is connected through a USB cable 244, 246, 248 and 250, respectively. It will be appreciated by those having ordinary skill in the art that the same number of devices are connected to the host computer, utilizing only one USB port on the computer, but now comprising five rather than seven USB cables.

FIG. 6C shows a preferred embodiment of the present invention which includes a host computer 260, connected through a USB cable 262 to a peripheral 264 having an upstream port 265. Device 264 is a compound device and thus has both hub functionality as well as device functionality as described in connection with the electronic and mechanical device 140 in FIG. 4. Device 264 is identical to device 140 as shown in FIG. 4. Device 264 is connected to a second device 266, which is connected to device 268, which is connected to device 270, and which terminates by connection to device 272. Since each of the devices 264 through 272 are identical to device 140 it will be appreciated by those of ordinary skill in the art that device 264 may be connected to device 266 by utilizing an upper docking port on device 266 and a lower docking port on the upper device 264. Each successively lower device is similarly connected directly through upper and lower docking ports on each of the electronic and mechanical devices. By providing a direct electromechanical interconnection between each device, it entirely eliminates the rat's nest of cables as shown in FIGS. 6A-6B; the embodiment of the invention effectively eliminates all cables other than one cable from the uppermost device 264 to the host computer 260.

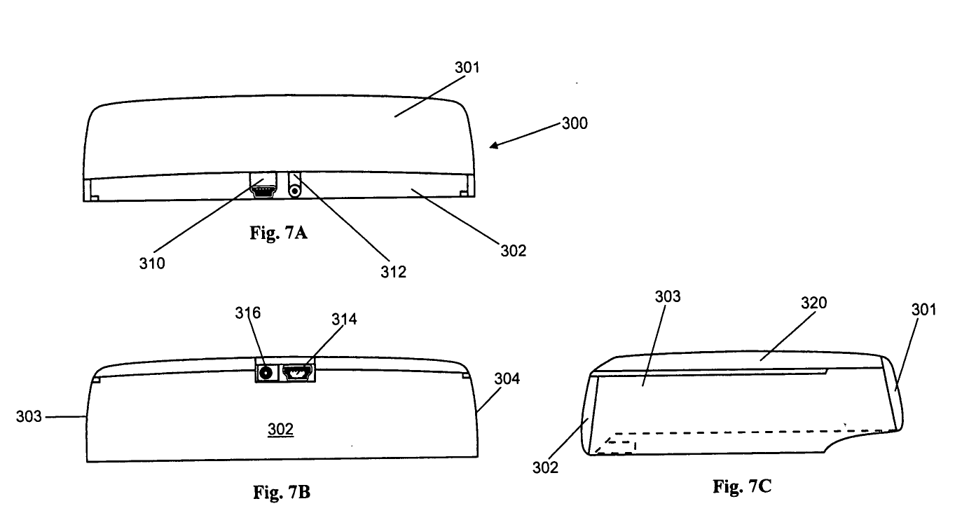

FIGS. 7-12 illustrate one embodiment of a housing for the electronic and mechanical system of the present invention. It will be readily understood that many types of housings are possible for interconnecting two adjacent electronic and mechanical devices in a manner that eliminates a separate cable between the two devices. Furthermore, as will be explained, the devices shown in FIGS. 7-12 in addition to including mechanical-electrical data signal interconnections, also include electromechanical power interconnections and mechanical interlocking means. Thus, in addition to eliminating data signal wires, the embodiment shown in FIGS. 7-12 also eliminates all but one power connection cable to a standard 110 volt power source.

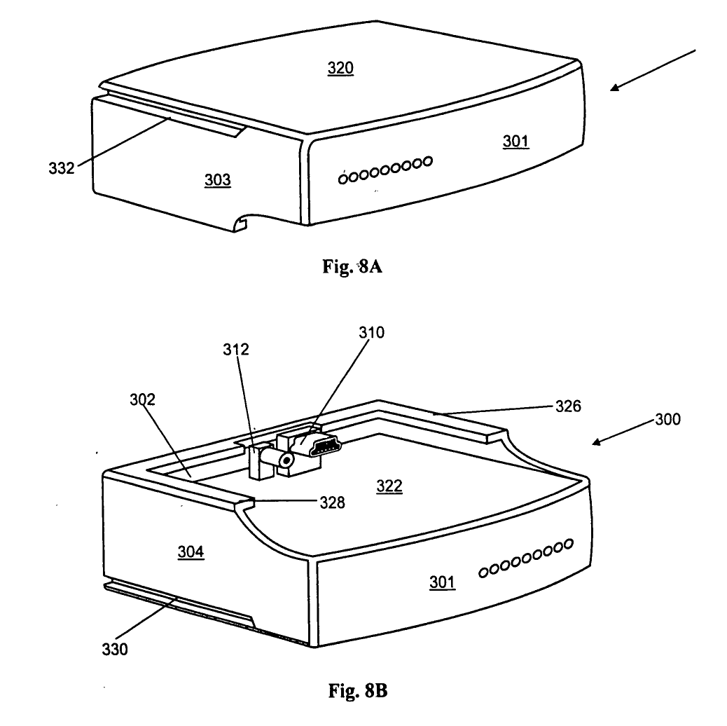

The embodiment shown in FIG. 7 comprises a housing 300 having a front wall 301, a rear wall 302, and side walls 303 and 304. Within housing 300 all of the electronic subassemblies as described above are contained. With reference to FIG. 7A, it will be seen that at the lower edge of the rear wall 32, and thus within the opening defined by housing 300, there is mounted a data interconnection 310 and a power interconnection 312. The housing 300 also includes on rear wall 302 a mating interconnection for data 314 and for power 316 exterior of the housing. The housing 300 includes a top wall 320 as shown best in FIG. 8A, and a bottom wall 322, as seen best in FIG. 8B where the housing 300 is shown inverted.

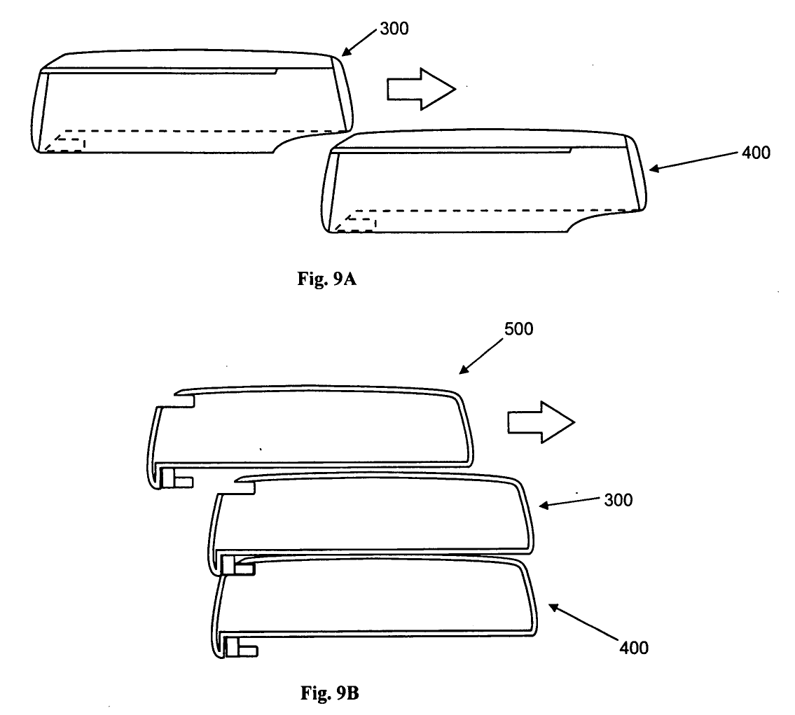

Housing mechanical interlocking means comprises rails and slots. The lower edges of side walls 303 and 304 include in-turned rails 326 and 328. The side walls 303 and 304 extend below (or above as illustrated in the inverted position of FIG. 8B) of bottom wall 322 where it will also be seen that rear wall 302 extends below bottom wall 322. The upper edges of side walls 303 and 304 include slots 330, in side wall 304 and 332 in side wall 303. As may be seen best in FIG. 9, the housings 300 may be stacked one upon another thereby minimizing the space required for the devices on the user's computer desk. As seen in FIG. 9A, two housings, 300 and 400 are mechanically interconnected by sliding the upper housing 300 from the rear of housing 400 so that the rails engage the slots and thereby mechanically align and position housing 300 relative to housing 400. As seen in FIG. 9B, housings 300 and 400 have been mechanically connected one above the other and the figure additionally shows a third housing 500 being moved into position from the rear of housings 300 and 400 until the electromechanical data signal and power interconnections are engaged.

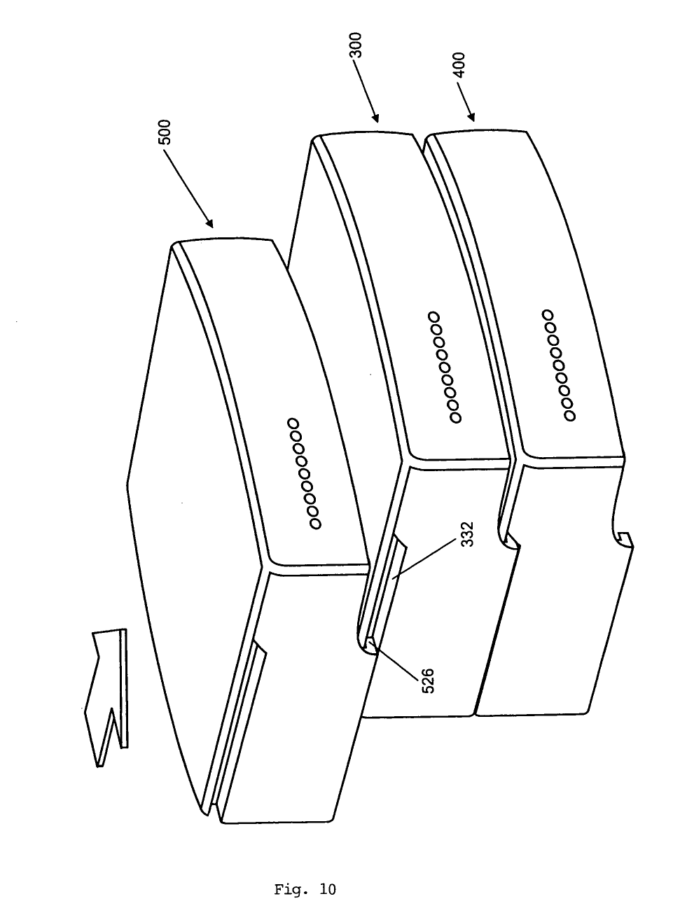

FIG. 10 shows the housings 500, 300 and 400 in the partially assembled configuration as shown in FIG. 9B but in perspective view where it may be seen that a rail, such as 526, is in sliding engagement with the slot 332 in housing 300.

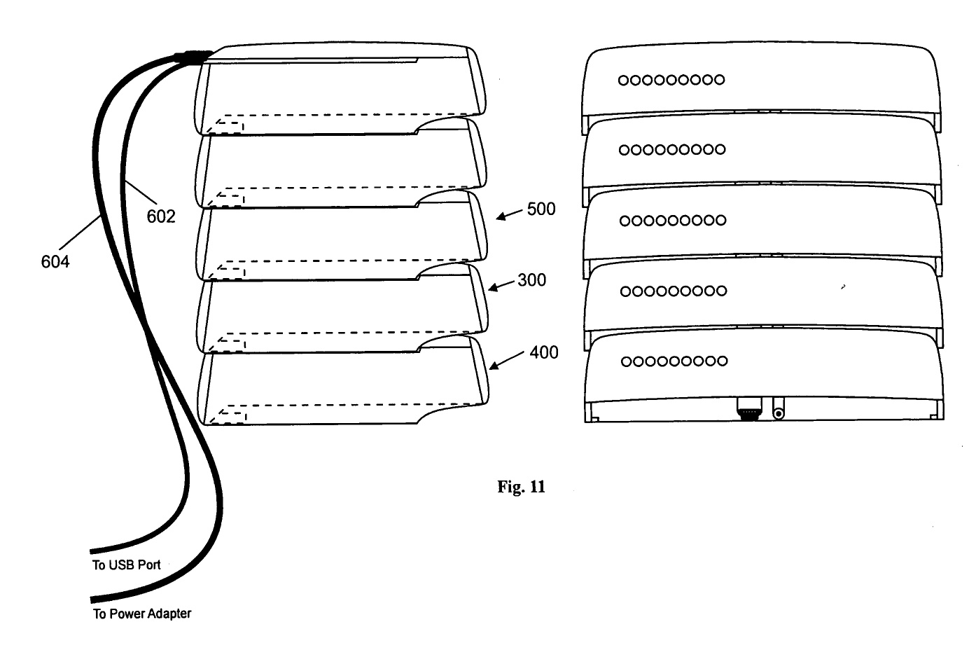

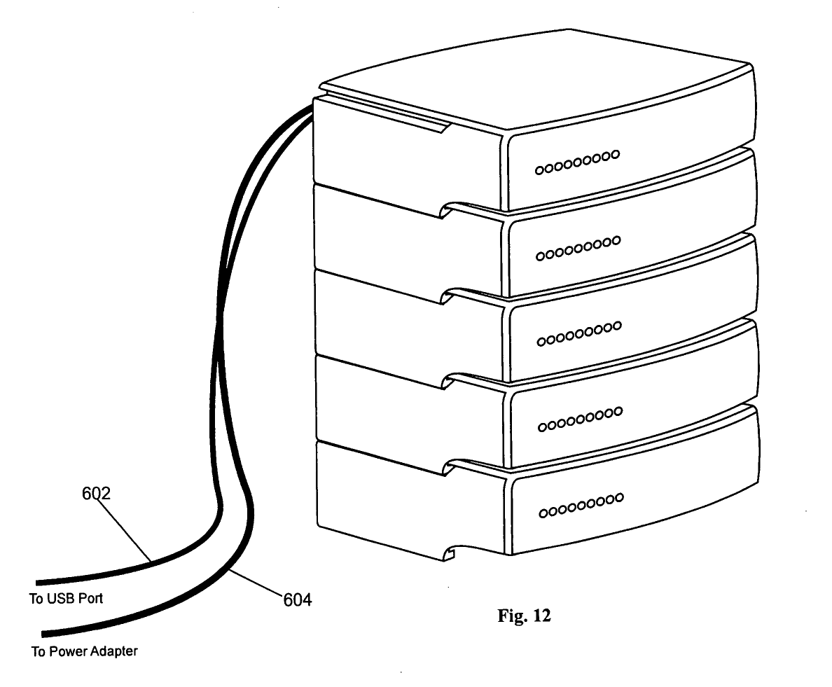

In FIG. 11, there is shown a completed stack including five of the housings such as housings 300, 400, and 500 including two cables to the uppermost housing, 600, including a USB cable 602, and a power connection cable 604. FIG. 12 shows the five housings stacked in fully assembled condition including a cable to the USB port of a computer and a power cable to a source of electrical power. A separate power cable may not be required depending upon the number of devices and hubs attached to the host, since a limited amount of power may be obtained for a hub or device directly from the host.

While the electronic and mechanical interconnection system as described in FIGS. 7-12 is only exemplary of various mechanical configurations that could be used for vertically stacking five housings, it will be seen that this particular configuration minimizes space on a computer user's desk to the footprint of one of the housings. It will be understood by one of ordinary skill in the art that there are other ways for mechanically interlocking housings in a vertical stack in the manner such that each housing is stacked upon another housing, so that as the two housings are positioned relative to one another they concurrently provide data signal and power interconnection between the two housings.

The above description of particular embodiments of the electronic and mechanical system of the present invention are not meant to be restrictive and the sole scope of the invention is set forth in the accompanying claims.

1. An electronic and mechanical system for interconnecting a host computer with devices comprising:
a first electronic and mechanical device including a housing, a first electromechanical interconnection for data communication with the host computer and a second electromechanical interconnection for data communication with a second device;
a second device including a housing and first and second electromechanical interconnection to said first device and a third device, respectively; and
each said device including a hub controller, a device controller and a non-removable function, said hub controller in data communication with said first electromechanical interconnection and said device controller, and said device controller in data communication with said device function.

2. The electronic and mechanical system of claim 1 wherein said device first and second electromechanical data communication interconnection comprises a USB male or female interface.

3. The electronic and mechanical system of claim 2 wherein said first device first USB interface is connected to said computer and said second USB interface is of the oppose sex to the first USB interface and is connected to a mating USB interface on said second device.

4. The electronic and mechanical system of claim 1 wherein said first device first USB interface is female and said first device second interface is male.

5. The electronic and mechanical system of claim 4 wherein said housing has a rear wall and said USB male interface is mounted at the lower edge and interiorly of the housing, and said USB female interface is mounted adjacent the upper edge of the rear wall exteriorly of the housing.

6. The electronic and mechanical system of claim 1 wherein each housing includes mechanical interlocking means for positioning, aligning and maintaining housings in a vertical stack.

7. The electronic and mechanical system of claim 6 wherein the USB female interface is connected through a standard USB cable to the host.

8. The electronic and mechanical system of claim 7 wherein at least one of said housings includes a power interconnection to a 110 volt power source.

9. The electronic and mechanical system of claim 7 wherein said uppermost housing is provided power through said USB interface, and wherein each housing includes means for distributing power to adjacent housings.

10. A USB electronic and mechanical system for interconnecting a host computer with at least two electronic and mechanical devices, each device comprising a hub controller, a device controller and a non-removable device function; and
a housing for each said electronic and mechanical device including a first USB port having either a male or female electromechanical interface and a second USB port having an electromechanical interface of the opposite sex;
whereby said devices are electronically and mechanically engaged in data communication through mating of said USB ports of opposite sex.

11. The USB electronic and mechanical system of claim 10 additional comprising:
a first electrical power interconnection for powering said device and a second electrical power interconnection for powering a second device;
said first and second said electrical power interconnections comprising electrical connectors of opposite sex.

12. The USB electronic and mechanical system of claim 11 wherein said first electrical power interconnection includes a cable and standard 110 volt power plug.

13. The USB electronic and mechanical system of claim 10 wherein said housings are vertically stacked.

14. The USB electronic and mechanical system of claim 10 wherein said housings are mechanically positioned, aligned and maintained in a vertical stack.

15. A USB electronic and mechanical system for interconnecting a host computer and at least two peripheral devices, comprising:
a first electronic and mechanical device having a housing with two pairs of electromechanical interconnections, one of each pair comprising a USB port and the other of each pair comprising an electrical power connector;
said first electronic and mechanical device including a host controller, a device controller and a device function;
a second electronic and mechanical device having a housing with two pairs of electromechanical interconnections, one of each pair comprising a USB port that matingly engages said USB port of one of said pair of said first electronic and mechanical device, and the other of each pair comprising an electrical power connector that matingly engages said electrical power connector of one of said pair of said first electronic and mechanical devices; and said second electronic and mechanical device including a host controller, a device controller and a device function.
